(19) United States
(12) Patent Application Publication
(10) Pub. No.: US 2002/0188789 A1
(43) Pub. Date: Dec. 12, 2002

(54) Wireless modem device

(75) Inventors: Seung-Beom Kim, San Diego, CA (US); Young-Keun Kim, San Diego, CA (US); Gwan-Hee You, San Diego, CA (US); Jin-Soo Kim, San Diego, CA (US); Sidney-Sangbum Park, Poway, CA (US)

Correspondence Address: Jonathan Y. Kang, Esq., Lee & Hong P.C., 11th Floor, 221 N. Figueroa Street, Los Angeles, CA, 90012-2601, US

(73) Assignee: CYBERLANE INC.

(21) Appl. No.: 09/880,542

(22) Filed: Jun. 11, 2001

(51) Int. Cl. G06F 13/00

(52) U.S. Cl. 710/305

(57) ABSTRACT

A PCMCIA type wireless modem comprises an interface module connected to the portable PC to receive a data packet. The interface module includes a single UART and attribute memory, interrupt signal generator connected to the interface module to receive a first interrupt signal and to output a second interrupt signal. The second interrupt signal is enabled after the complete data packet is received in the memory. The modem card includes a processor connected to the interface module and responsive to the second interrupt signal. When the second interrupt signal is enabled, the processor accesses the data packet from the memory. The interrupt signal generator comprises a counter responsive to the first interrupt signal, a register, a comparator to compare output values of the counter and the register, and a pulse generator to produce the second interrupt signal when the output of the counter matches a stored value of the register.

### BACKGROUND OF THE INVENTION

1. Field of the Invention

The present invention relates generally to PCMCIA card type CDMA wireless data modems, and more particularly to an interrupt signal generator circuit used in the wireless modem to provide two independent data communication channels simultaneously using one UART chip.

2. Discussion of the Related Art

A PCMCIA CDMA modem card is a peripheral of the PCMCIA card type that allows notebook PC users to have access to the Internet through CDMA communication channels, such as IS-95A/B/C defined in wireless communication standard. A CDMA communication channel is composed of a “signaling traffic channel” and a “traffic channel.”

The traffic channel is a dedicated data channel for peer-to-peer data communication. The signaling traffic channel is for handling message protocol for valued added services, such as SMS (Short Message Service) messages and control messages between the CDMA mobile station and the base station. The traffic channel allocates data to users through a call setup procedure and releases data through a call termination procedure, but the signaling traffic channel is always available without a call setup procedure. The traffic channel and the signaling traffic channel are completely separate and able to establish data communication simultaneously.

The CDMA system is a base station and mobile station that provides wireless voice communication services using code division multiple accesses. CDMA technology enables wireless digital data communication. All information exchanged between the mobile station and the base station is in the form of digital packets. The basic RF frequency used by CDMA system is divided into 800 MHz and 1900 MHz. They are generally referred to as “DCS band” and “PCS band”, respectively. The DCS system and PCS system are differentiated by the maximum transmitting data rate per second. The DCS system can exchange 8 kbit of user data per second and the PCS system can exchange 13 kbit of user data per second.

Generally, the user data is transmitted through a local channel called the “traffic channel,” and control information between the mobile station and the base station is transmitted through the “signaling traffic channel.” The signaling traffic channel and the traffic channel are separate from each other. The signaling traffic channel is used mainly to transmit control information to maintain CDMA wireless link (such as call process or power control) and service coverage, but is also used for value added services such as SMS (short message service).

To use a traffic channel, a mobile user has to go through a process called the “call setup procedure”. When the call setup procedure is successfully completed, the user is able to use a dedicated traffic channel through which the user can make a voice conversation or gain Internet access. In contrast, the signaling traffic channel does not require an additional call setup procedure and it is available at any time. Because the signaling traffic channel is a common resource that is shared by many users, traditionally the transfer information is relatively less compared to a dedicated traffic channel. Thus, the signaling traffic channel is generally easier to transmit from a base station to a mobile station. Due to an increasing number of Notebook PC users and the expansion of CDMA coverage area, the CDMA data modem, which gives Notebook PC users an Internet connection when traveling, is being developed.

The PCMCIA is an interface standard designated for a notebook PC peripheral device and usually has two card slots per PC that can be used simultaneously. These slots are mostly allotted for use with an extended memory card, flash memory card, data/fax modem card, ATA disk, or network card (Ethernet). There are total of 26-address lines and 16-data lines. That is, the maximum transmitting data rate for reading and writing in one address cycle is 16 bit, 1 word and 8 bit, 1 byte. A PCMCIA modem card uses a serial COM port for host interface as a CDMA modem card.

The PCMCIA card development originated from the effort to replace the floppy diskette drive. In order to develop the portable computer, PCS personal computer required the replacement of the floppy diskette drive with a device that had low power consumption. The PCMCIA interface was made for this reason. The PCMCIA provides a parallel bus interface so that it can be applied to use a floppy diskette drive as well as other peripheral devices. The other required structural condition for substituting a floppy diskette drive was the ability to insert/remove (devices) freely without having to shut down the PC. For that reason, the PCMCIA socket ground pin is made longer than the rest of the pins. When the PCMCIA card is inserted to the slot, the ground pin connects first and the rest of the pins connect later. Conversely, when the PCMCIA card is removed from the slot, the power supply pin and the ground pin separate first and the ground pin separate last. This is to prevent possible electrical damage when inserting or removing the PCMCIA card.

When a PCMCIA card is inserted to the PCMCIA slot of a notebook PC, the operating system (OS) will allocate available COM port resource and initialize by reading the card information structure (CIS) stored in the attribute memory of the PCMCIA card. When those procedures are successfully completed, the application program can communicate with the PCMCIA card through the COM port allocated to the PCMCIA card by OS. The COM port interface within the PCMCIA card is realized through a UART chip and the local microprocessor communicates with the UART chip through a RS-232 interface. It is possible for a traditional PCMCIA data modem to establish data communication with one COM port, but since the CDMA data modem can establish data communication with the traffic channel and signaling traffic channel simultaneously, it requires at least two COM ports and generally utilizes two UART chips. This invention concerns the method of providing two separate data communication channels using one UART chip and an attribute memory used for PCMCIA card initialization.

A PCMCIA card that can be inserted or removed during the use of PC needs the support of PC OS (Operation System). This allows the user to smoothly utilize the PC without interference. The PCMCIA card management is composed of a HBA (Host Bus Adaptor), a socket service, a card service, and a client driver. The HBA connects the PC expansion bus and the PCMCIA card in hardware, and its role is to sense PCMCIA card insertion/removal and send out a notification signal. The socket service also provides power to the card and converts PC expansion bus signal to PCMCIA and vice versa.

The socket service is a software interface that accesses the HBA directly. The socket service accesses the control register of the status register within the HBA and accesses the PCMCIA card. The card service is an upper level software interface of the socket service. The card service accesses the HBA through the socket service. The client driver is a device driver utilizing an upper level software interface provide in the PCMCIA card. The HCA senses PCMCIA card insertion/removal from the socket and generates a notification signal that notifies the card service.

When the notification generated signal represents card insertion, the card service activates the registered OS client driver and the client driver begins the initialization process. The card service needs to read the CIS (Card Information Structure) tuple data by accessing attribute memory in the PCMCIA card. These access requests of the client are accessed through a card service, a socket service and the HBA. The CIA tuple is a descriptive data unit for the applicable PCMCIA card, and the format is defined in advance according to its contents. Each CIS tuple is linked in each other's link list, and the attribute memory capacity is 256 bytes. After reading each CIS tuple, the client driver analyzes the CIA tuple and requests system resources from the system. The system allocates system resources if it is available to a client driver and the client driver sets the HBA configuration according to the resource. After the HBA configuration is set according to PCMCIA's requested resource, the role of the client driver is complete. The PCMCIA card can be used through an application program that is in the system. The PCMCIA card that cannot receive resources from the system will fail card initialization and cannot be used.

The necessary system resource for the PCMCIA modem card is the serial COM port. The modem card is not designed to be used by the serial COM port, but because of the backward compatibility of the application software, the COM port is required. The serial COM port is interface standard necessary for desktop PC external data modem derive. It is also necessary for the application program that needs to access the external data modem service through the serial COM port. In order to use these application programs on a Notebook PC, it's necessary to access the PCMCIA modem card through the serial COM port.

Generally, a method of utilizing the serial COM port is to use, for example, PCMCIA modem card that has an UART chip inside. The HBA and UART chip of the PCMCIA modem card interfaces a PCMCIA bus and the UART chip and a local microprocessor (PCMCIA card) interface to satisfy serial COM port interface, RS-232 standard.

The CDMA modem card communicates using the CDMA technique with a base station using the traffic channel and the signaling traffic channel to interchange user data. Because those two channels are independent, they can receive data simultaneously. As a result, to efficiently use the CDMA modem card that has such qualities requires the application of more than one data communication channel for interface with the host system. Therefore, the conventional CDMA modem card uses two independent serial COM ports.

The bi-directional transmission rate of a UART chip used for the serial COM port is a minimum of 300 bits per second and can increase to 1115.2 Kbit at the maximum. On the other hand, the CDMA modem speed is about 8 Kbit per second for the DSC system and about 13 Kbit per second for the PCS system. In contrast, user data sent by the signaling traffic channel are not continuous, but intermittent. In addition, the quantity of data transmitted in one occurrence is small. Therefore, the average transmission speed is much lower compared to the user data sent by a traffic channel. Even if the transmission speed of a UART chip is faster than the CDMA modem (in delivering user data by a traffic channel to the host application program), it is necessary to use a serial COM port using an UART chip because of the backward compatibility of the host program as mentioned before.

However, because sending user data by a signaling traffic channel to the host application program does not need to satisfy the backward compatibility, it is not economical to use an extra UART chip for the PCMCIA card. For information sent by an extra communication channel such as SMS, which sends by signaling traffic channel, the value added service data or data to monitor CDMA modem status are manufacturer dependent. Therefore, it is free from backward compatibility.

FIG. 1 illustrates a block diagram of a conventional CDMA modem card 280 using two UART chips. In particular, a local microprocessor 200 communicates with an application program 215 and a status check program 220 of the host through UART #1 205 and UART #2 chip 210, respectively.

A web browser program, such as Internet Explorer or Netscape Navigator, is the application program 215 and the status check program 220 is a utility program 220 provided by the CDMA modem card manufacturer. The CIS tuple data stores in an attribute memory 225 of a modem card.

When the CDMA modem card 280 is inserted to the PCMCIA slot, the HBA 230 generates an insertion interrupt 240 to the card service 235 and activates the client driver 245 and reads through the HBA 230. The system resource, requested through CIS tuple data by the CDMA modem card 280 to a host, becomes two serial COM ports. This assigns a separate COM port number for each UART chip and operates an application program and a status check program independently. When the system resources are successfully allocated, the client driver 245 sets the HBA configuration accordingly. When the configuration setting is completed, the host program communicates with the local microprocessor 200 of the data CDMA modem card 280. Unlike an application program that communicates through the serial COM port, the status check program 220 is manufacturer dependent and the data transfer rate is not sufficient enough to require an UART chip. Therefore, it is not economical to use a UART chip for status check program 220.

### SUMMARY OF THE INVENTION

Accordingly, the present invention is directed to a wireless modem device that substantially obviates one or more of the problems due to limitations and disadvantages of the related art.

It is an object of the present invention to provide a wireless modem devices that uses a single UART chip in lieu of two UART chip while providing two independent data communication channels.

It is another object of the present invention to provide a wireless modem device that is economical to manufacture due a reduced number of chips used thereon.

It is another object of the present invention to provide a wireless modem device using an interrupt handling device that reduces interrupt processing time of a local microprocessor.

Additional features and advantages of the invention will be set forth in the description that follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a wireless modem device for use with a portable computer having a host bus adapter adapted to transfer a data packet, comprises an interface module connected to the host bus adapter to receive the data packet, the interface module including a UART and a memory; an interrupt signal generator connected to the interface module to receive a first interrupt signal and to output a second interrupt signal, wherein the second interrupt signal is enabled after the data packet is received in the memory; and a processor connected to the interface module and responsive to the second interrupt signal, wherein when the second interrupt signal is enabled, the processor access the data packet from the memory.

According to one aspect of the present invention, the interrupt signal generator comprises a counter responsive to the first interrupt signal; a register responsive to the processor; and a comparator to compare output values of the counter and the register. The interrupt signal generator further comprises a pulse generator to produce the second interrupt signal when the output of the counter matches a stored value of the register. Preferably, the counter is at least an 8-bit counter, and the register is at least an 8-bit register.

According to another aspect of the present invention, the register is loaded with a register value from the processor and the second interrupt signal is enabled when a total number of first interrupt signal is received by the interrupt signal generator is equal to the register value.

A method of communicating between a wireless modem device and a portable computer having a host bus adapter adapted to transfer a data packet, is also achieved. Such method comprises the steps of receiving each byte of the data packet in the memory; the interface module generating the first interrupt signal to the interrupt signal generator in response to the each byte of the data packet being stored in the memory; generating the second interrupt signal from the interrupt signal generator when an entire data packet is received in the memory; and the processor accessing the memory to retrieve the data packet in response to the second interrupt signal received from the interrupt signal generator.

According to one aspect of the present invention, the register in the interrupt signal generator is loaded with a register value received from the processor and the second interrupt signal is enabled when a total number of the first interrupt signal received by the interrupt signal generator is equal to the register value.

It is to be understood that both the foregoing general description and the following detailed description are exemplary and explanatory and are intended to provide a further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and, together with the description, serve to explain the principles of the invention.

FIG. 1 illustrates a block diagram of a conventional CDMA modem card;

FIG. 2 illustrates a PCMCIA interface block diagram of a CDMA modem card according to a preferred embodiment of the present invention;

FIG. 3 illustrates a block diagram of the preferred embodiment of the CDMA modem card shown in FIG. 2;

FIG. 4 illustrates an initialization flow diagram of the CDMA modem card;

FIG. 5 illustrates a decimated interrupt signal generator according to the preferred embodiment of the present invention;

FIG. 6 illustrates a data transfer flow diagram from the host program to the local microprocessor; and

FIG. 7 illustrates a data fetch flow diagram from the attribute memory.

### DETAILED DESCRIPTION OF THE PREFERRED EMBODIMENTS

Hereinafter, the present invention will be described with respect to the preferred embodiment illustrated in the annexed drawings.

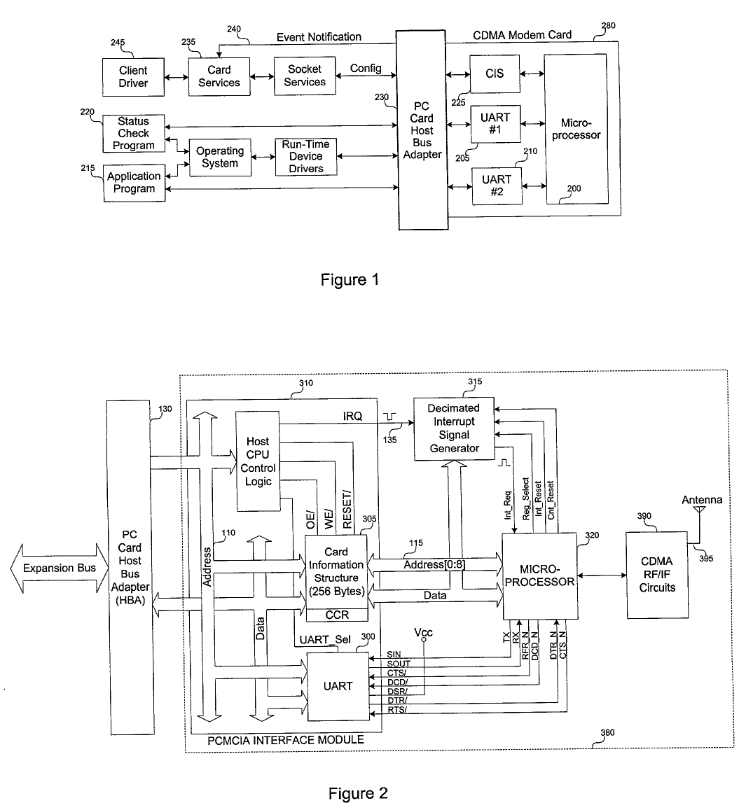

FIG. 2 illustrates a PCMCIA interface block diagram of the CDMA modem card 380 according to a preferred embodiment of the present invention. As shown in FIG. 2, the CDMA modem card 380 comprises a PCMCIA interface module 310, a decimated interrupt signal generator 315, a microprocessor 320, a CDMA RF/IF circuit 390 and an antenna 395.

The interface module 310 is preferably of the type having one UART and the attribute memory. Preferably, the present inventions uses TL16PC564A from Texas Instrument® which has an UART chip 300 and an attribute memory 305. The attribute memory 305 comprises 256 byte DPRAM and has access to the PCMCIA bus 110 and the local bus 115.

According to the present invention, the microprocessor 320 used in the CDMA modem card 380 preferably is MSM 3100 chip from Qualcomm®. The microprocessor 320 interfaces with the UART chip 300 that is inside of the PCMCIA interface module 310 through the RS-232 protocol. The local microprocessor 320 writes necessary CIS tuple data in the attribute memory when receiving power due to a modem card insertion to the PCMCIA slot.

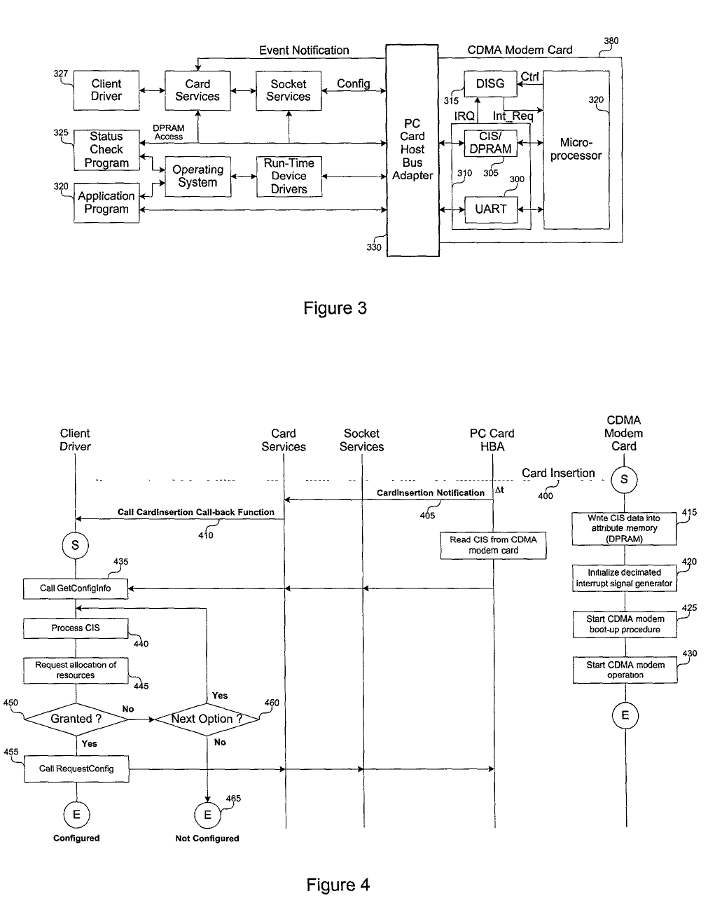

Referring to FIG. 3, the client driver 327 of the host reads CIS tuple data by accessing the attribute memory 305 of the PCMCIA interface module 310 through the HBA 330 when receiving a card insertion signal from the HBA 330. The client driver 327 receives a system resource allocation according to CIS tuple data and sets the HBA configuration.

Conventionally, the attribute memory of PCMCIA card is no longer in use when the above procedure is complete, but with the present invention, the attribute memory 305 is continuously used as a secondary communication channel to transmit user data. When the host application accesses an attribute memory and writes data, the PCMCIA interface module creates an interrupt signal to the microprocessor. The interrupt signal is usually generated every time a host program writes to the attribute memory. Thereafter, the microprocessor accesses an attribute memory and reads the data when an interrupt signal is generated. Furthermore, according to the preferred embodiment of the present invention, there is provided an interrupt signal generator 315 that counts interrupt signals from the PCMCIA interface module 310 and compares that value with a saved value in a register preferably resident in the interrupt signal generator 315. An interrupt request signal is only sent to the microprocessor 320 when the number stored in the register matches with that of the counter storing the number of interrupts received from the PCMCIA interface module 310. Such an interrupt signal generator 315 eliminates the over use of interrupt signals and allows the attribute memory 305 to operate efficiently.

Referring to FIGS. 2 and 3 and according to the preferred embodiment of the present invention, the CDMA modem card 380 uses a PCMCIA interface device 310 with a DISG (Decimated Interrupt Signal Generator) 315. An application program 320 allows backward compatibility of data communication through the UART chip. According to the preferred embodiment, the status check program 325 communicates with the microprocessor 320 of the CDMA modem card 380 through the attribute memory 305 instead of a second UART chip, thus eliminating the necessity of the second UART chip. In particular, the status checks program 325 accesses the card service, socket service and the HBA 330 directly in order to access the attribute memory 305 of the CDMA modem card 380.

The host CPU control logic shown in FIG. 2 generates an interrupt signal from TL16PC564A when the host program writes data by accessing the attribute memory. According to the present invention, an interrupt signal 135 is not directly provided to the microprocessor 320, but is provided to the DISG 315. The DISG 315 counts the number of interrupt signals and saves it in the internal register 520. The DISG 315 sends out the interrupt signal to the local microprocessor 320 only when the numbers agree with the saved value.

A flow diagram of the initialization procedure for a CDMA modem card 380 is shown in FIG. 4. An interrupt signal 405 to a card service from the HBA 330 is generated when the CDMA modem card 380 is inserted 400 into the PCMCIA slot. After the card insertion, the HBA 300 supplies power to the CDMA modem card 330 which then performs inner firmware of the microprocessor and starts the boot-up procedure. The microprocessor 320 sets the inner control register of the PCMCIA interface module 310 and writes the CIS tuple data in the attribute memory 305 in step 415.

This is followed by DISG initialization in step 420 and initialization in step 425 for the CDMA modem card 380. When the initialization is completed, the CDMA modem card 380 starts the normal CDMA modem operation in step 430. The client driver 327 accesses in step 435 the attribute memory 305 in the CDMA modem card 380 through the HBA 330 and reads the CIS tuple data. The client driver 327 preferably deals with tuple data one by one and requests a necessary system resource. When this is successfully completed in step 450, the client driver 327 sets the HBA configuration according to an allocated system resource. If the client driver cannot allocate the requested system resource, it will request with the next resource option in step 460. When all the resource requests fail, the CDMA modem card 380 will be left without initialization and cannot be used.

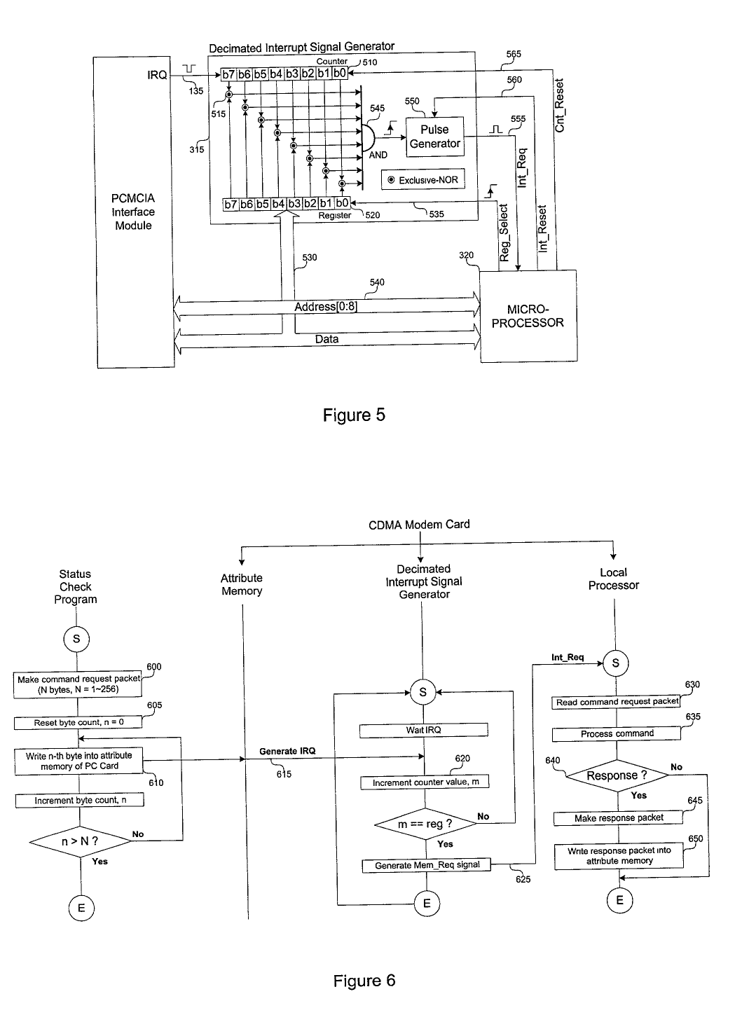

FIG. 5 illustrates the decimated interrupt signal generator 315 according to the preferred embodiment of the present invention. Referring to FIG. 5, the interface device 310 generates an interrupt signal 135 when the host program writes data by accessing the attribute memory 305 in the interface module 310 through the HBA 330. The interrupt signal 135 is received by the DISG 315 and increases the value of a counter 510, preferably an 8 bit counter, by one as shown in FIG. 5. When the counter value overflows, it starts from 0 again. The output of the counter 510 is preferably inputted to exclusive-NOR logics 515. The value of the internal register 520 is determined by the microprocessor 320. The output of the register 520 is also preferably inputted to the exclusive-NOR logic 515.

When desiring to load a certain value to the register 520, the data bus 530 is first loaded with such value and Reg_Select 535 is enabled. The value is then loaded into the register 520. At this time, any address value that is not being used by the microprocessor 320 in the address range may be used. The outputs of the counter 510 and the register 520 are provided to the AND gate 545 through the exclusive-NOR logic 515. The output of the AND gate 545 is provided to a pulse generator 550. The NOR logic 515 and the AND logic 545 perform the function of a comparator such that when the value of the counter 510 and the register 520 match, then the output of the comparator is enabled.

The pulse generator 550 preferbly detects the rising edge of input warning and outputs as a single pulse. This single pulse, Int_Reg 555 is provided to the microprocessor 550. When using the DISG 315, it is possible to provide a portion of an interrupt signal from the interface module 310 to the microprocessor 320. For example, when the host program wants to transfer 128 bytes of data to the CDMA modem card 380, the host program causes the microprocessor 320 to the load the register 520 to a hexadecimal value of 7F. Then as soon as the 128th data is written, the interrupt signal 555 is generated to the microprocessor 320 from the DISG 315. The local microprocessor 320 accesses the attribute memory 305 and reads the 128 bytes of data. The counter 510 and pulse generator 550 in the DISG 315 can be reset by Int_Reset 560 and Cnt_Reset 565 signals from the local microprocessor 320.

According to the preferred embodiment, rather than generating 128 interrupt signals to transfer 128 byte data, the DISG 315 decreases the processing load of the microprocessor 320 to transfer 128 bytes of data with one interrupt signal.

Although the preferred embodiment of the DISG 315 is described in terms of counter, register, logic circuits, and pulse generator, the DISG 315 may be implemented using software and/or programmable logic array without deviating the gist of the present invention. In addition, the size of the counter (e.g., 8 bit counter) may be of any other bit counter (e.g., 12 bit counter) known to one of ordinary skill in the art.

The flow diagram in FIG. 6 shows a status check program transferring data to a local processor of the CDMA modem card 380 through the attribute memory 305. First, the status check program prepares a command request packet that contains a data status check program in step 600 and resets counter variable in step 605. The status check program then writes each byte to the attribute memory in step 610. The interrupt signal 615 is generated from the interface module 310 and is provided to the DISG 315. The DISG 315 counts the registered interrupt signals. When the value matches with the loaded value of the register 520 then the interrupt signal is provided to the microprocessor 320 in step 625.

Referring to FIG. 6, the microprocessor that receives the interrupt signal reads the command request packet from the attribute memory in step 630. The microprocessor 320 processes to read the command packet and decides whether the command needs a response in steps 635 and 640. If the command packet needs a response, the microprocessor 320 prepares a response packet in step 640 and writes to the attribute memory 305 in step 650. If the command packet does not need a response, then the local processor 320 completes the command packet processing.

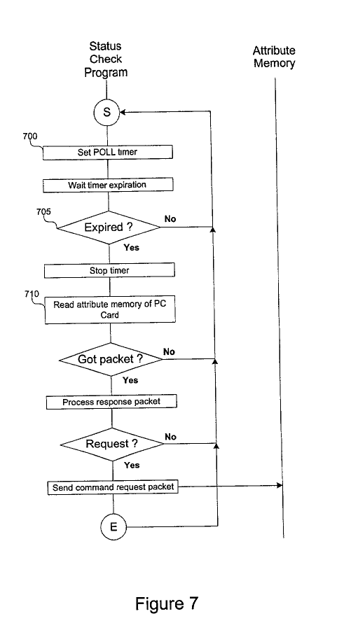

The flow chart diagram of FIG. 6 shows the procedure of the status check program in FIG. 7. It is possible for the microprocessor 320 to sense data arrival because an interrupt signal generates automatically when the host program writes data to the attribute memory 305. On the other hand, because the host program does not have a sensing mechanism to detect when the microprocessor 320 writes data to the attribute memory 305, the host program does not know when to read the data. Therefore, the host program uses a memory polling method to resolve those problems. That is, there is a select fixed expiration time on the software timer and as soon time expires in step 705, the status check program accesses the attribute memory 305 and reads the data.

According to the preferred operation, the host program needs to know in advance that the microprocessor 320 is transferring the data. For that reason, it uses the protocol relationship of the command request and the response packet. The microprocessor 320 makes the response packet when the command request is received and writes data to the attribute memory 305. The host program transmits a command request to the microprocessor 320 of the CDMA modem card 380 and waits for a predetermined time and accesses the attribute memory 305 to read the response packet. If the microprocessor 320 wants to send data to the host program first, then the host program sends a dummy command request to the microprocessor 320 to transfer data.

It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

What is claimed is:

1. A wireless modem device for use with a portable computer having a host bus adapter adapted to transfer a data packet, the modem device comprising:
an interface module connected to the host bus adapter to receive the data packet, the interface module including a UART and a memory;
an interrupt signal generator connected to the interface module to receive a first interrupt signal and to output a second interrupt signal, wherein the second interrupt signal is enabled after the data packet is received in the memory; and
a processor connected to the interface module and responsive to the second interrupt signal, wherein when the second interrupt signal is enabled, the processor access the data packet from the memory.

2. The wireless modem of claim 1, wherein the interrupt signal generator comprises:
a counter responsive to the first interrupt signal;
a register responsive to the processor; and
a comparator to compare output values of the counter and the register.

3. The wireless modem of claim 2, wherein the interrupt signal generator further comprises a pulse generator to produce the second interrupt signal when the output of the counter matches a stored value of the register.

4. The wireless modem of claim 2, wherein the counter is at least an 8-bit counter.

5. The wireless modem of claim 2, wherein the register is at least an 8-bit register.

6. The wireless modem of claim 2, wherein the register is loaded with a register value from the processor and the second interrupt signal is enabled when a total number of first interrupt signal is received by the interrupt signal generator is equal to the register value.

7. A wireless modem device for use with a portable computer having a host bus adapter adapted to transfer a data packet, the modem device comprising:
a host CPU control unit;
an attribute memory connected to the host CPU control unit for storing the data packet;
a UART;
an interrupt signal generator connected to the host CPU control unit to receive a first interrupt signal and to output a second interrupt signal, wherein the second interrupt signal is enabled after the data packet is received in the memory; and
a processor connected to the attribute memory and the UART and responsive to the second interrupt signal, wherein when the second interrupt signal is enabled, the processor access the data packet from the attribute memory.

8. The wireless modem of claim 7, wherein the interrupt signal generator comprises:
a counter responsive to the first interrupt signal;
a register responsive to the processor; and
a comparator to compare output values of the counter and the register.

9. The wireless modem of claim 8, wherein the interrupt signal generator further comprises a pulse generator to produce the second interrupt signal when the output of the counter matches a stored value of the register.

10. The wireless modem of claim 8, wherein the counter is at least an 8-bit counter.

11. The wireless modem of claim 8, wherein the register is at least an 8-bit register.

12. The wireless modem of claim 8, wherein the register is loaded with a register value from the processor and the second interrupt signal is enabled when a total number of first interrupt signal is received by the interrupt signal generator is equal to the register value.

13. A method of communicating between a wireless modem device and a portable computer having a host bus adapter adapted to transfer a data packet, wherein the modem device comprises an interface module connected to the host bus adapter to receive the data packet, the interface module including a UART and a memory; an interrupt signal generator connected to the interface module to receive a first interrupt signal and to output a second interrupt signal; and a processor connected to the interface module, the method comprising the steps of:
receiving each byte of the data packet in the memory;
the interface module generating the first interrupt signal to the interrupt signal generator in response to the each byte of the data packet being stored in the memory;
generating the second interrupt signal from the interrupt signal generator when an entire data packet is received in the memory; and
the processor accessing the memory to retrieve the data packet in response to the second interrupt signal received from the interrupt signal generator.

14. The method of claim 13, wherein the interrupt signal generator comprises:
a counter responsive to the first interrupt signal;
a register responsive to the processor; and
a comparator to compare output values of the counter and the register.

15. The method of claim 14, wherein the interrupt signal generator further comprises a pulse generator to produce the second interrupt signal when the output of the counter matches a stored value of the register.

16. The method of claim 15, wherein at each enablement of the first interrupt signal, the counter is incremented by one.

17. The method of claim 16, wherein the register is loaded with a register value received from the processor and the second interrupt signal is enabled when a total number of the first interrupt signal received by the interrupt signal generator is equal to the register value.
